(19) United States
(12) Patent Application Publication
(10) Pub. No.: US 2003/0007783 A1
(43) Pub. Date: Jan. 9, 2003

(54) Recording/reproducingdisk control device and disc apparatus comprising the same

(76) Inventor: Takumi Kinoshita, Saijo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/019,261

(22) PCT Filed: Apr. 27, 2001
(86) PCT No.: PCT/JP01/03681

(30) Foreign Application Priority Data
Apr. 28, 2000 (JP) 2000-130459

(51) Int. Cl. H04N 5/92; H04N 5/781

(52) U.S. Cl. 386/95; 386/96; 386/125

(57) ABSTRACT

The present invention provides a recording and reproduction disk control unit which can record recording management data also during storage of DV data without affecting recording of the DV data and can easily select recording management information to be read into a memory provided in the recording and reproduction disk control unit at startup.

The recording and reproduction disk control unit comprises a data recording and reproduction means (104) for recording and reading DV data and recording management information onto/from a disk-shaped recording medium, an image/voice data management means (106) for monitoring whether there is a room for DV data recording by the data recording and reproduction means (104) or not, and a recording management information management means (107) which temporarily holds the recording management information and outputs the same to the data recording and reproduction means (104) when the image/voice data management means (106) detects that there is a room for DV data recording by the recording and reproduction means (104).

### TECHNICAL FIELD

The present invention relates to a recording and reproduction disk control unit and a disk device employing the same, which control recording and reproduction of image/voice data inputted successively through a digital interface onto/from a disk, and, more particularly, to one which records image/voice data as well as recording management information which includes information to manage image/voice data onto a disk.

### BACKGROUND ART

In recent years, a disk device such as a magnetic disk device and an optical disk device, whose performance in recording capacity and transfer rate has been rapidly enhanced, is increasingly employed for recording and reproduction of image/voice data as moving image data. Particularly, performance enhancement of a hard disk device is remarkable and a hard disk device is utilized for an image server which performs storage and distribution of image/voice data, an editor for editing image/voice data, or the like.

Image/voice data are continuous data with no interruption (hereinafter, referred to as “stream data”) compared with such data as a program handled by a computer. That is, it is required that the stream data should be continuously read from a disk at each constant cycle so as to be taken outside during reproduction and the externally inputted stream data should be continuously written onto a disk at each constant cycle during recording.

FIG. 6 is a diagram exemplifying a data area when a magnetic disk such as a hard disk is used as a disk.

A disk 1 shown in FIG. 6 is provided with a management area 3 for recording recording management information for image/voice data which is recorded on its outer circumference side, a management area backup 4 having the same contents as those of the management area 3 for increasing reliability of information, and data area 2 for recording image/voice information in the rest part.

In the data area 2, image/voice data are recorded, which are addressed from 0 in a unit of minimum data from the outermost circumference part. That is, the minimum data unit is treated as a frame unit when the image/voice data are DV data.

Recording management information required for recording and reproducing image/voice data or edit information indicating an edit state are recorded in the management area 3, and the similar data as those in the management area 3 are also recorded in the management area backup 4. Even when the recording management information in one of the management area 3 and the management area backup 4 cannot be read or its contents are improper, data is enabled to read from the other recording management information, so that important information such as image/voice data recorded so far or editing results is not lost.

FIG. 7 is a diagram exemplifying conventional recording management information recorded in the management area 3.

As shown in FIG. 7, the recording management information recorded in the management area 3 includes recording area information and INDEX information.

The recording area information includes a recording start frame address which indicates an address of image/voice data recorded in the data area 2, a reproduction start frame address which indicates an address of image/voice data that are in the data area 2 when the image/voice data are reproduced, and a final recording frame address which indicates a final position of voice/image data recorded in the data area 2.

The number of index registrations which indicates the number of registered indexes and frame addresses which indicate each address position of each index are recorded in the INDEX information. Here, the index indicates a mark for editing which is added by a user to image/voice data recorded in the data area 2.

While there also exist other pieces of recording management information than those described above, they have no direct relation to the present invention, and therefore the detailed descriptions thereof will be omitted.

A conventional recording and reproduction disk control unit has recording management information to manage recorded image/voice data on a memory provided in the unit body, and records the recording management information into the management area 3 of the disk 1 when the image/voice data are recorded or an editing operation is ended. When the unit body is restarted after power disconnection, the recording management information is read out from the disk 1 to the memory provided in the recording and reproduction disk control unit and is used as recording management information of the image/voice data.

Therefore, even when power is disconnected while the unit body is recording or editing the image/voice data, recording management information recorded before power disconnection can be taken out at startup of the recording and reproduction disk control unit, so that the recording management information or edit information on the image/voice data is not lost.

Further, the recording management information is recorded not only in the management area 3 but also in the management area backup 4 so as to prevent the recording management information from being totally lost, since the recording management information under recording may be destroyed by power being disconnected while the recording management information is being recorded onto a disk.

However, when the recording management data are recorded onto a disk while recording of the image/voice data is stopped, the recording management information on data under recording is all lost in case of power failure or the like during recording of the image/voice data. Meanwhile, when the recording management information is doubly recorded while the image/voice data are recorded onto a disk, stream data which are transmitted at certain intervals with no data loss may not be recorded onto a disk in a case where the capacity of the recording management is high. That is, a serious defect as a lack in the image/voice data may be caused.

Further, while the recording management information is stored separately in the two areas of the disk, it is not known from which area the recording management information should be read into the memory provided in the unit body or whether power disconnection such as power failure is generated during recording of the image/voice data, when the conventional recording and reproduction disk control unit is powered off and is restarted.

The present invention is made to solve the above-mentioned problems and has for its object to provide a recording and reproduction disk control unit and a disk device employing the same, which can record recording management information without affecting recording of the stream data also during storage of image/voice data, can easily select the recording management information to be read into a memory provided in the recording and reproduction disk control unit at startup, and further can judge whether abrupt power disconnection due to power failure or the like is generated in the course of recording of the image voice data or not.

### DISCLOSURE OF THE INVENTION

According to the present invention, a recording and reproduction disk control unit which controls recording and reproduction of digital data onto/from a disk-shaped recording medium that has a data recordable area where the digital data composed of either one or both of image data and voice data are recorded and one or more management information areas where recording management information employed for management of the digital data is recorded, comprises: a data recording and reproduction means for recording digital data and recording management information onto the disk-shaped recording medium and reading the digital data and the recording management information from the disk-shaped recording medium; an image/voice data management means for monitoring whether there is a room for recording of digital data by the data recording and reproduction means or not; and a recording management information management means for temporarily holding recording management information and outputting the recording management information to the data recording and reproduction means when the image/voice data management means detects that there is a room for recording of the digital data by the data recording and reproduction means.

According to the present invention, there is provided the image/voice data management means which monitors whether there is a room for recording of digital data or not and informs the recording management information management means of a storage request of recording management information when there is a room for data recording by the data recording and reproduction means, thereby preventing a lack in stream data, which is due to overflowing data when the recording management information is recorded. Further, since the recording management information is recorded during recording of the digital data, loss of the recording management information can be prevented even when power disconnection due to power failure or the like is generated during recording of digital data.

According to the present invention, in the above-described recording and reproduction disk control unit, the disk-shaped recording medium has two or more management recording areas, and the data recording and reproduction means records recording management information in the two or more management information areas in turn when recording the recording management information onto the disk-shaped recording medium.

According to the present invention, a disk-shaped recording medium has two or more management information areas and the data recording and reproduction means records recording management information into the two or more management information areas in turn, whereby it is possible to prevent all the recording management information from being lost, even when power disconnection due to power failure or the like is generated during recording of any recording information.

According to the present invention, in the above-described recording and reproduction disk control unit, the recording management information recorded on the disk-shaped recording medium includes recording recency information which indicates whether the recording management information is most newly recorded, as backup information.

According to the present invention, the recording management information includes recording recency information as backup information, whereby the recording management information management means can easily select the recording management information to be read by referring to the recording recency information at startup of the recording and reproduction disk control unit.

According to the present invention, in the above-described recording and reproduction disk control unit, the recording management information recorded on the disk-shaped recording medium includes disconnection-during-recording information which indicates whether or not power disconnection of the disk recording and reproduction control unit is generated while the recording management information is recorded on the disk-shaped recording medium, as backup information.

According to the present invention, the recording management information includes disconnection-during-recording information as backup information, whereby the recording management information management means can easily select the recording management information to be read by referring to the disconnection-during-recording information at startup of the recording and reproduction disk control unit.

According to the present invention, in the above-described recording and reproduction disk control unit, the recording management information recorded on the disk-shaped recording medium includes operational state information which indicates whether the recording management information is recorded on the disk-shaped recording medium during recording of digital data or not, as backup information.

According to the present invention, the recording management information includes operational state information as backup information, whereby the recording management information management means can judge whether power disconnection due to power failure or the like is generated during recording of digital data or not by referring to the operational state information at startup of the recording and reproduction disk control unit.

According to the present invention, in the above-described recording and reproduction disk control unit, backup information, information concerning recording of the recording management information, is included in the recording management information recorded on the disk-shaped recording medium, the backup information is not included in the recording management information temporarily held by the recording management information management means, and the recording management information management means adds the backup information to the recording management information temporarily held by the recording management information management means to output to the data recording and reproduction means.

According to the present invention, the backup information is not included in the recording management information held by the recording management information management means, thereby reducing a capacity of the recording management information held by the recording management information management means.

According to the present invention, in the recording and reproduction disk control unit, the recording management information recorded on the disk-shaped recording medium includes backup information as information concerning recording of the recording management information, the recording management information temporarily held by the recording management information management means includes the backup information, and the recording management information management means updates the backup information included in the recording management information temporarily held by the recording management information management means to output to the data recording and reproduction means.

According to the present invention, the backup information is included in the recording management information held by the recording management information management means, whereby the recording management information management means can output the recording management information to the data recording and reproduction means promptly, when the recording management information management means does not have to update the backup information to output the recording management information.

According to the present invention, in the above-described recording and reproduction disk control unit, the recording management information management means selects the recording management information which is most newly recorded with no power disconnection generated during recording from recording management information recorded on the disk-shaped recording medium at startup of the recording and reproduction disk control unit.

According to the present invention, proper recording management information can be selected at startup of the recording and reproduction disk control unit.

According to the present invention, there is provided a disk device having the above-described recording and reproduction disk control unit built-in.

According to the present invention, the recording and reproduction disk control unit is provided, so that the function held by the disk device can be mounted in an electric/electronic circuit, whereby cost reduction and downsizing of the disk device for recording and reproducing image/voice data is possible, as compared with a case where the recording and reproduction disk control unit and a disk device are used separately.

### BRIEF DESCRIPTION OF DRAWINGS

FIG. 1 is a block diagram illustrating a recording and reproduction disk control unit according to a first embodiment of the present invention.

FIG. 2 is a diagram exemplifying recording management information according to the first embodiment of the present invention.

FIG. 3 is a diagram for explaining the structure on a disk according to the first embodiment of the present invention.

FIG. 4 is a diagram for explaining a ring buffer according to the first embodiment of the present invention.

FIG. 5 is a block diagram illustrating a constitution of a disk device according to a second embodiment of the present invention.

FIG. 6 is a diagram exemplifying a data area of a magnetic disk.

FIG. 7 is a diagram exemplifying conventional recording management information.

### BEST MODE TO EXECUTE THE INVENTION

(Embodiment 1)

Hereinafter, a recording and reproduction disk control unit according to a first embodiment of the present invention will be described with reference to figures.

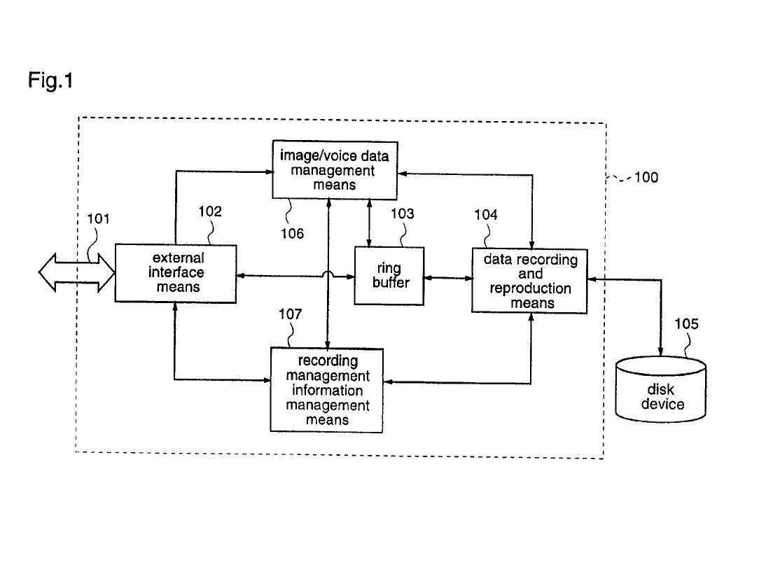

FIG. 1 is a block diagram illustrating a constitution of the recording and reproduction disk control unit according to the first embodiment.

A recording and reproduction disk control unit 100 shown in FIG. 1 comprises an external interface means 102, a ring buffer, 103, a data recording and reproduction means 104 which records/reproduces recording management information and image/voice data in a DV format (hereinafter, referred to as “DV data”) onto/from a disk device 105, an image/voice data management means 106, and a recording management information management means 107 having a volatile memory (not shown) in which recording management information is stored. Here, the recording management information is information employed for managing recording and reproduction of the DV data, which is recorded alternately in two areas of a management information area and a management information backup area of the disk device 105.

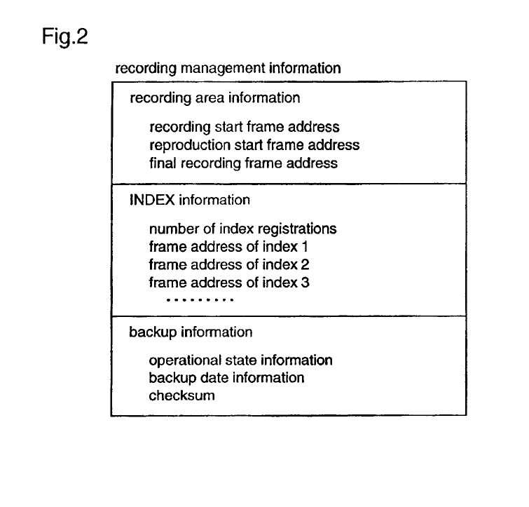

FIG. 2 is a diagram exemplifying the recording and reproduction information stored in the volatile memory held by the disk device 105 or the recording management information management means 107.

The recording management information includes three pieces of information, recording area information, INDEX information, and backup information. While the recording management information may include other pieces of information than the one described above, they have no direct relation to the present invention, and therefore, the descriptions thereof will be omitted.

The recording area information includes a recording start frame address which indicates an address position where DV data to be recorded are stored, a reproduction start frame address which indicates an address position where DV data to be reproduced are stored, and a final recording frame address which indicates a final position of recorded DV data.

The recording start frame address is increased by ones every time DV data are stored, and when it exceeds the final recording frame address, the final recording frame address is also increased by ones with the recording start frame address. The reproduction start frame address is updated to increase a frame address of DV data to be subsequently outputted by ones every time DV data are reproduced. The final recording frame address indicates a final address position of recorded DV data, and the DV data from the reproduction start frame address to the final recording frame address may be reproduced when DV data are reproduced. For simplifying the description, it is considered that the DV data recorded in the disk device 105 are single and no fragment occurs to the DV data in the first embodiment.

The number of index registrations which indicates the number of registered indexes and frame addresses which indicate each address position of each index are recorded in the INDEX information.

The backup information is information indicating a state when the recording management information is stored in the disk device 105, which is updated when the recording management information is stored in the disk device 105. Operational state information is information indicating whether or not the recording management information is stored while DV data are recorded or edited. While the operational state information being “under operation” indicates that the recording management information is stored while DV data are recorded or edited, the operational state information being “under suspension” indicates that the recording management information is stored while recording of the DV data is suspended. Backup date information is information indicating date when the recording management information is stored in the disk device 105, which is used to distinguish which recording management information recorded in the two areas of the disk device 105 is new. A checksum is a word size and has a value that is 0 when the overall recording management information is added in words. The checksum is used to confirm whether power disconnection due to power failure or the like is generated during recording of the recording management information or not. The checksum is the last one to be recorded in the disk device 105 among the recording management information.

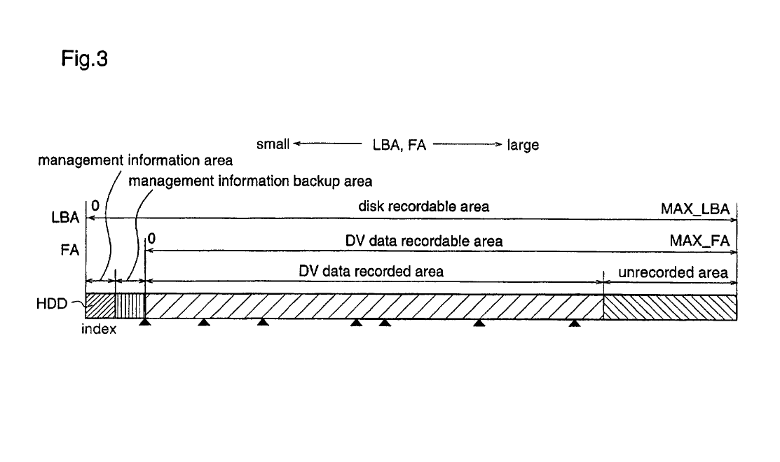

FIG. 3 is a diagram for explaining a data storage state in a recording area in the disk device 105.

In FIG. 3, image/voice data are arranged sequentially in a DV data recordable area in frames. Here, a management information area is an area where recording management information is recorded, and management information backup area is an area where recording management information is recorded as a backup of the recording management information recorded in the management information area. While the management information backup area is arranged next to the management information area in the first embodiment as shown in FIG. 3, the management information backup area may be arranged in the innermost circumference of a disk-shaped recording medium of the disk device 105, that is, in an area with a larger logical block address (LBA), thereby to reduce an access time for storing the management information. Further, when the management information area and the management information backup area are arranged in the center of the disk-shaped recording medium, the access time can be reduced further.

The external interface means 102 is connected to an IEEE1394 bus 101, which transfers DV data and digital data such as a control instruction (command) between the external interface means 102 and an external device such as a digital VCR (not shown). The external interface means 102 is constituted by a PHY circuit that executes an interface control of a physical layer, a LINK circuit that executes an interface control of a logical layer, and the like, and transfers DV data received from the external device to the ring buffer 103 at recording of the DV data, while it outputs DV data received from the ring buffer 103 to the external device at reproduction of the DV data.

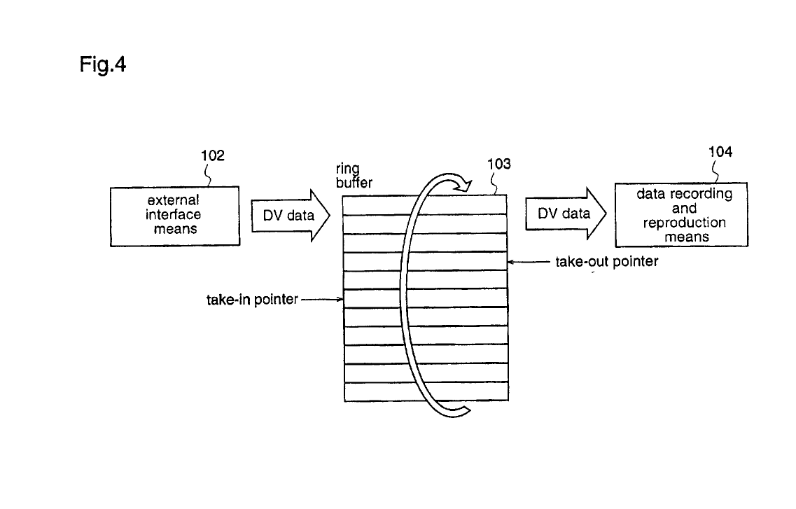

FIG. 4 is a diagram for explaining a function of the ring buffer 103 at recording of DV data.

As shown in FIG. 4, DV data transferred from the external interface means 102 are stored in a position indicated by a take-in pointer of the ring buffer 103. After the DV data are stored, an address of the take-in pointer is incremented. At this time, when the address of the take-in pointer exceeds the maximum address of the ring buffer 103, the address of the take-in pointer is returned to its minimum value. The DV data are transmitted from the external interface means 102 to the ring buffer 103 at certain intervals (approximately every 33 ms in case of DV data).

In a case where the DV data are stored in the ring buffer 103 and the disk device 105 is capable of receiving the DV data, the data recording and reproduction means 104 informs the recording management information management means 107 of a frame leading address request and receives a frame address where DV data are to be recorded as present frame information from the recording management information management means 107. Then, the data recording and reproduction means 104 takes out the DV data from an address position of a take-out pointer of the ring buffer 103 and records it in an address position indicated by the present frame information of the disk device 105.

Further, after taking out the DV data from the ring buffer 103, the data recording and reproduction means 104 increments the address of the take-out pointer, while it returns the address of the take-out pointer to its minimum value when it exceeds the maximum address of the ring buffer 103.

In a normal state, data that are not transferred to the disk device 105 among the DV data stored in the ring buffer 103 are 0 or 1. There is a lack in DV data recording when the transfer of the DV data to the disk device 105 is delayed until the ring buffer 103 is filled with the DV data.

Further, the data recording and reproduction means 104, when receiving recording management information from the recording management information management means 107, ends recording of the DV data into the disk device 105 which is being executed at the time and then records the received recording management information into either of the management information area and management information backup area of the disk device 105.

Here, it will be described which of the management information area and the management information backup area the data recording and reproduction means 104 selects as an area where the recording management information is recorded. The data recording and reproduction means 104, having a flag buffer not shown), records the recording management information into the management information backup area when a flag stands in the flag buffer. The flag of the flag buffer is erased when the recording is ended. The data recording and reproduction means 104 records the recording management information into the management information area when the flag does not stand in the flag buffer. The flag is set in the flag buffer when the recording is ended. In this way, the data recording and reproduction means 104 records the recording management information into the management information area and the management information backup area alternately.

Further, at reproduction of DV data, the data recording reproduction means 104, when receiving a frame address of the DV data to be reproduced from the recording management information management means 107, obtains the DV data of the address from the disk device 105 and transfers the same to the ring buffer 103.

The image/voice data management means 106 receives a recording start request, a recording stop request, a reproduction start request, and a reproduction stop request from the external interface means 102. Receiving the recording start request, the image/voice data management means 106 monitors the take-out pointer and take-in pointer of the ring buffer 103, and when detecting that a difference between the take-out pointer and the take-in pointer is under a prescribed threshold value, that is, the DV data remaining in the ring buffer 103 is under a prescribed amount, and there is a room for recording the DV data into the disk device 105 by the data recording and reproduction means 104, informs the recording management information management means 107 of a storage request of the recording management information. Further, receiving the recording stop request, the image/voice data management means 106 ends monitoring the ring buffer 103 and informs the recording management information management means 107 of the storage request of the recording management information and an instruction for making the operational state information of the backup information included in the recording management information “under suspension”.

Further, the image/voice data management means 106, when receiving the reproduction start request, informs the recording management information management means 107 of an instruction for sequentially outputting a frame address from the reproduction start frame address of the recording area information included in the recording management information to the data recording and reproduction means 104. Receiving the reproduction stop request, the image/voice data management means 106 informs the recording management information management means 107 of an instruction for stopping an output of the frame address.

The recording management information management means 107, having a volatile memory (not shown) where the recording management information is stored, holds the recording management information in the memory temporarily, that is, until power of the recording and reproduction disk control unit 100 is turned OFF. Receiving the storage request of the recording management information from the image/voice data management means 106, the recording management information management means 107 updates the operational state information, backup date information, and checksum of the backup information of the recording management information stored in the volatile memory, and takes out the recording management information with its backup information updated from the volatile memory to output to the data recording and reproduction means 104. At this time, when the recording management information management means 107 receives an instruction for making the operational state information of the backup information “during suspension” as well as the storage request of the recording management information from the image/voice data management means 106, the recording management information management means 107 outputs the operational state information to the data recording and reproduction means 104 as “under suspension”, or otherwise outputs the operational state information as “under operation”.

Further, the recording management information management means 107, when receiving the frame leading address request from the data recording and reproduction means 104, returns the recording start frame address of the recording area information which is included in the recording management information stored in the volatile memory to the data recording and reproduction means 104 as the present frame information and increments the recording start frame address. When the recording start frame address exceeds the final recording frame address, the final recording frame address is incremented with the recording start frame address. When all the data areas are used to enable no more recording, the data recording and reproduction means 104 is informed of that effect.

Further, the recording management information management means 107, when receiving an instruction for modifying, adding, or erasing the INDEX information of the recording management information or the like from the external interface means 102, modifies, adds, or erases the INDEX information of the recording management information in the volatile memory or the like and outputs the recording management information modified or the like to the data recording and reproduction means 104.

Further, the recording management information management means 107, when receiving an instruction for sequentially outputting the reproduction start frame address of the recording area information included in the recording management information to the data recording and reproduction means 104 from the image/voice data management means 106, outputs the reproduction start frame address of the recording area information to the data recording and reproduction means 104, increments the reproduction start frame address, and outputs the reproduction start frame address to the data recording and reproduction means 104. The recording management information management means 107 repeats this operation until it receives an instruction for stopping the output of the reproduction start frame address from the image voice data management means 106 or the value of the incremented reproduction start frame address is equal to the final recording frame address of the recording area information.

The disk device 105 is a hard disk device (HDD) equipped with an IDE interface. A recording area of the hard disk device is managed in sectors with 512 bytes as a sector, and a logical block address (LBA) is allocated to each sector. A leading area (an area with a smaller LBA) of the recordable area of the disk device 105 is allocated as the management information area and other areas are allocated as areas where DV data are recorded as data areas. The data area is managed as a frame address (FA) in frames of the DV data.

Next, an operation of the recording and reproduction disk control unit 100 will be described.

First, a recording operation of the DV data by the recording and reproduction disk control unit 100 will be described.

The external interface means 102 receives a recording instruction through the IEEE1394 bus 101 and informs the image voice data management means 106 of a recording start request. Then, the image/voice data management means 106 starts monitoring the ring buffer 103. Subsequently to the recording instruction, the external interface means 102 also receives the DV data through the IEEE1394 bus 101 and transfers the received DV data to the ring buffer 103.

When the DV data are stored in the ring buffer 103, the data recording and reproduction means 104 detects it and informs the recording management information management means 107 of a frame leading address request. Receiving a frame address where the DV data are to be recorded as the present frame information from the recording management information management means 107, the data recording and reproduction means 104 takes out the DV data stored in the take-out pointer from the ring buffer 103 and records the same into the disk device 105 according to the frame address indicated by the present frame information. Then, the data recording and reproduction means 104 increments an address of the take-out pointer of the ring buffer 103. In this way, the data recording and reproduction means 104 sequentially records the DV data into the disk device 105.

While the data recording and reproduction means 104 takes out the DV data from the ring buffer 103 and records the same into the disk device 105, the image/voice data management means 106 monitors the take-out pointer and take-in pointer of the ring buffer 103 and informs the recording management information management means 107 of a storage request of the recording management information, when a difference between the take-out pointer and the take-in pointer is under a prescribed threshold value such as 1. Receiving the storage request of the recording management information from the image voice data management means 106, the recording management information management means 107 updates the operational state information, backup date information, and checksum of the backup information of the recording management information stored in the volatile memory (not shown), takes out the recording management information with its backup information updated from the volatile memory, and transfers the same to the data recording and reproduction means 104. Since there is no instruction indicating “under suspension” from the image voice data management means 106 in this case, the operational state information is updated as “under operation”. The backup date information of the backup information is updated to the date at that time. The checksum of the backup information is updated to the number that is 0 when the whole recording management information is added in words.

Receiving the recording management information from the recording management information management means 107, the data recording and reproduction means 104 records the recording management information into the management information backup area in the disk device 105 when the flag stands in the flag buffer (not shown), while it records the same into the management information area when the flag does not stand, after recording of the DV data into the frame address at that time is ended. Then, the flag of the flag buffer is modified.

When the external interface means 102 ends receiving the DV data and receives a recording end instruction, the external interface means 102 informs the image/voice data management means 106 of the recording stop request. Then, the image/voice data management means 106 confirms whether the take-out pointer and take-in pointer of the ring buffer 103 are identical or not, that is, whether recording of the DV data is ended or not. When the take-out pointer and the take-in pointer are not identical, the image/voice data management means 106 waits until they become identical and then informs the recording management information management means 107 of the storage request of the recording management information and an instruction for making the operational state information “under suspension”. Then, the recording management information management means 107 takes the operational state information of the backup information as “under suspension”, updates other backup information, and transfers the recording management information to the data recording and reproduction means 104. The data recording and reproduction means 104 records the recording management information into either the management information area or the management information backup area of the disk device 105 according to the flag of the flag buffer.

Next, a reproduction operation of the DV data by the recording and reproduction disk control unit 100 will be described.

The external interface means 102, when receiving a reproduction instruction through the IEEE1394 bus 101, informs the image/voice data management means 106 of a reproduction start request. The image/voice data management means 106 informs the recording management information management means 107 of an instruction for sequentially outputting the reproduction start frame address of the recording area information included in the recording management information to the data recording and reproduction means 104. Then, the recording management information management means 107 outputs the reproduction start frame address of the recording area information to the data recording and reproduction means 104 and increments the reproduction start frame address. The recording management information management means 107 outputs the incremented reproduction start frame address to the data recording and reproduction means 104, and continues this operation until the reproduction start frame address is equal to the final recording frame address or it receives an instruction for stopping the output of the reproduction start frame address from the image/voice data management means 106.

Receiving the reproduction start frame address from the recording management information management means 107, the data recording and reproduction means 104 takes out the DV data corresponding to the address from the disk device 105 and outputs the same to the ring buffer 103. When the DV data are stored in the ring buffer 103, the external interface means 102 takes out the DV data and transfers the same to the external device (not shown) through the IEEE1394 bus 101. In this way, the DV data are sequentially taken out from the disk device 105 and outputted to the external device through the external interface means 102.

Next, a description will be given of a case where the external interface means 102 receives an instruction for modifying, adding, or erasing the recording management information.

For example, when the external interface means 102 receives an instruction for modifying the recording management information, it informs the recording management information management means 107 of contents of the modification. The recording management information management means 107 modifies the recording management information stored in the volatile memory (not shown) according to the contents of the modification and outputs the recording management information to the data recording and reproduction means 104. The data recording and reproduction means 104 records the recording management information into the disk device 105 according to the flag of the flag buffer (not shown). Adding or erasing the recording management information can be also executed similarly.

Next, an initial processing on startup of the body of the recording and reproduction disk control unit 100 will be described.

When the body of the recording and reproduction disk control unit 100 is turned ON and is started, the recording management information management means 107 takes out the recording management information recorded in both of the management information area and the management information backup area from the disk device 105 through the data recording and reproduction means 104. Then, the backup date information is compared, so that newer recording management information is selected, and the whole recording management information is added in words to confirm whether it results in 0 or not. In a case where the result of adding the whole recording management information in words is 0, the management information is stored in the volatile memory. In a case where it is not 0, which means that power disconnection such as power failure is generated during recording of the recording management information, older recording management information, that is, the non-selected recording management information is stored in the volatile memory.

Further, it is confirmed whether the operational state in the recording management information stored in the volatile memory is “under suspension” or not, thereby judging whether power disconnection due to power failure or the like is generated during recording of the DV data or not. That is, power failure or the like is found to be generated when the operational state information is “under operation”, and power failure or the like is found not to be generated when the operational state information is “under suspension”.

As described above, the recording and reproduction disk control unit 100 according to the first embodiment is provided with the image/voice data management means 106, which monitors the ring buffer 103 and informs the recording management information management means 107 of the storage request of the recording management information, when there is a room for recording data using the data recording and reproduction means 104, whereby the recording management information can be recorded without having such an influence as a lack in data on recording of stream data, and loss of the recording management information can be prevented even when power disconnection due to power failure or the like is generated during recording of image/voice data.

Further, the recording management information includes the backup information comprising the operational state information, the backup date information, and the checksum, whereby the recording management information management means 107 can easily select the recording management information to be read in the volatile memory at startup of the recording and reproduction disk control unit and can judge whether power disconnection due to power failure or the like is generated in the course of recording of image/voice data or not.

While, in the first embodiment, a description is given of a case where the disk device 105 is a hard disk device as an example, the disk device 105 may be an optical magnetic disk device, a DVD-RAM, or the like to achieve the same effect.

Further, while, in the first embodiment, a description is given of a case where a connection means between the recording and reproduction disk control unit 100 and the disk device 105 is of an IDE interface constitution as an example, the connection means between the recording and reproduction disk control unit 100 and the disk device 105 may be an interface means capable of transferring a digital signal such as an SCSI interface, and a constitution thereof is not restricted to that of the first embodiment.

(Embodiment 2)

Hereinafter, a disk device according to a second embodiment of the present invention will be described with reference to figures.

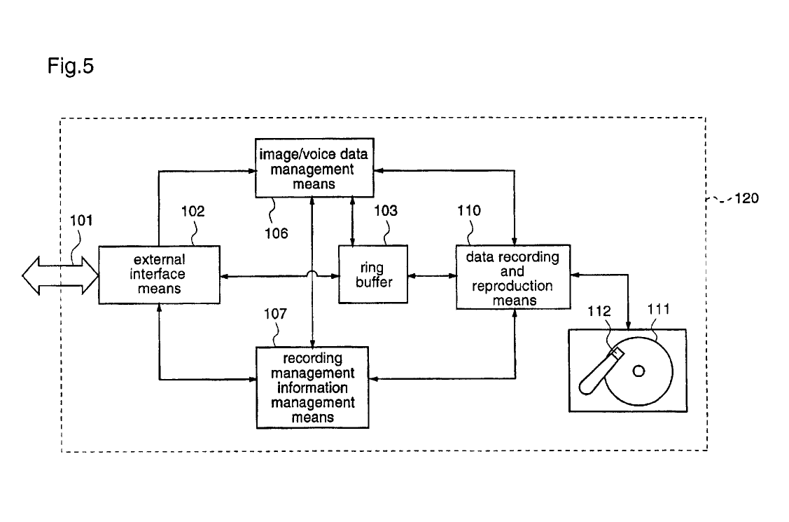

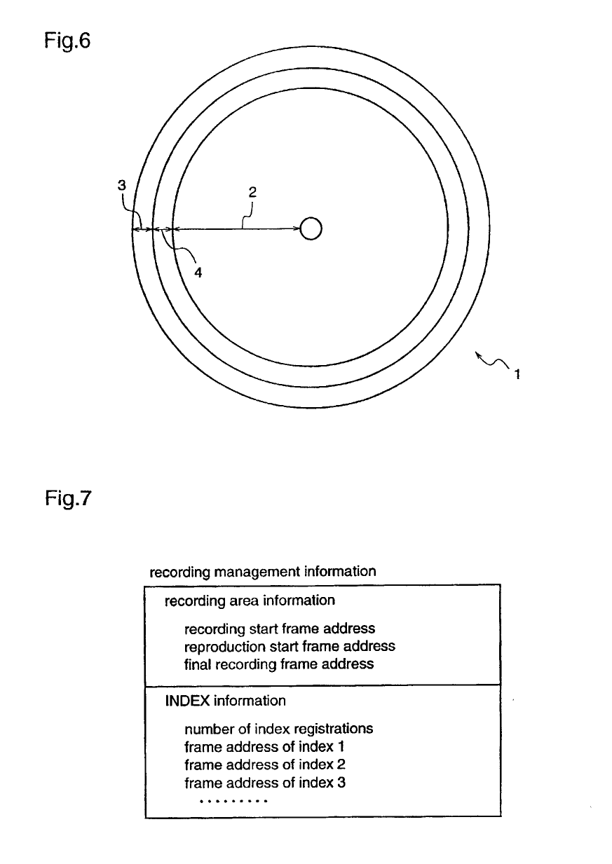

FIG. 5 is a block diagram illustrating a constitution of the disk device according to the second embodiment.

A disk device 120 shown in FIG. 5 comprises an external interface means 102, a ring buffer, 103, an image/voice data management means 106, a recording management information management means 107, a data recording and reproduction means 110, a magnetic disk 111, and a magnetic head 112. Constitutions and operations of the parts other than the data recording and reproduction means 110, the magnetic disk 111, and the magnetic head 112 are the same as those in the recording and reproduction disk control unit 100 in the first embodiment, and descriptions thereof will be omitted.

The data recording and reproduction means 110 is the same as the data recording and reproduction means 104 in the first embodiment except that it executes a control of writing or reading digital data onto/from the magnetic disk 111 through the magnetic head 112, instead of recording or reproducing data onto/from the disk device 105 through the IDE interface.

The magnetic disk 111 is a disk-shaped recording medium on which digital data are recorded.

The magnetic head 112 records digital data onto the magnetic disk 111 or reads digital data from the magnetic disk 111.

The disk device 120 according to the second embodiment is provided with respective blocks of the recording and reproduction disk control unit 100 shown in the first embodiment, has the same function as that of the recording and reproduction disk control unit 100, and executes the same operation as in the first embodiment for each request from an external device connected to the IEEE1394 bus 101.

As described above, the disk device 120 according to the second embodiment is equipped with the recording and reproduction disk control unit 100 in the first embodiment, whereby the function held by the disk device 105 in the first embodiment can be mounted in an electric/electronic circuit, so that cost reduction and downsizing of the disk device for recording and reproducing image/voice data is also possible as compared with a case where the recording and reproduction disk control unit 100 and the disk device 105 are used separately as in the first embodiment, in addition to the effect in the first embodiment being achieved.

While, in the first and second embodiments, when the storage request of the recording management information is notified from the image/voice data management means 106, the recording management information management means 107 stores all the recording management information stored in the volatile memory, for example, in the disk device 105, it is also possible that the recording management information management means 107 stores only the updated contents, for example. Further, when the recording management information stored in the volatile memory is not updated, the recording management information management means 107 does not have to output the recording management information even when it receives the storage request of the recording management information.

Further, while, in the first and second embodiments, the image/voice data management means 106 monitors the amount of data buffered in the ring buffer 103 and informs the recording management information management means 107 of the storage request of the recording management information, the recording management information management means 107 may output the recording management information at certain time intervals (every time the data for ten frames are recorded, for example), instead of outputting the recording management information when the recording management information management means 107 receives the storage request of the recording management information, in a case where the amount of the DV data transferred from the external interface means 102 to the ring buffer 103 is previously known, for example.

Further, while, in the first and second embodiments, the backup information includes the recording state information, the backup information does not have to include the recording state information when there is no need to judge whether power disconnection due to power failure or the like is generated in the course of recording of image voice data or not, for example.

Further, while, in the first and second embodiments, the data recording and reproduction means 104 and 110 record the recording management information in the management information area and the management information backup area alternately, the data recording and reproduction means 104 and 110 may record the recording management information in both of the management information area and the management information backup area when the operational state information of the backup information is “under suspension”.

Further, while, in the first and second embodiments, a description is given of a case where a magnetic disk is employed as a recording medium, an optical magnetic disk may be employed as the recording medium.

Further, while the recording and reproduction disk control unit 100 and the disk device 120 in the first and second embodiments are connected to the external device through the IEEE1394 bus 101, any buses which enable transferring and receiving image/voice data are available, and a constitution thereof is not restricted to constitutions in the respective embodiments.

Further, while date and hour when the recording management information is stored, for example, can be employed as the backup date information included in the backup information in the first and second embodiments, the backup date information such as date and hour is employed as an example, and it is not restricted to the backup date information such as date and hour as long as it is recording recency information that enables distinguishing new one between two pieces of recording management information. As an example of the recording recency information other than the backup date information, an integral number or the like which is incremented every time the recording management information is recorded can be raised. In this case, a lower number indicates older recording management information.

Further, while, in the first and second embodiments, the backup information includes the checksum as information indicating whether abrupt power disconnection due to power failure or the like is generated during recording of the recording management information or not as an example, the information is not restricted to the checksum as long as it is disconnection-during-recording information indicating whether abrupt power disconnection due to power failure or the like is generated during recording of the recording management information or not. As the disconnection-during-recording information other than the checksum, the same information as the recording recency information can be employed, for example. In this case, two pieces of recording newness information included in the same recording management information are compared, and power disconnection is generated during recording of the recording management information when they are different, while power disconnection is not generated during recording of the recording management information when they are identical.

Further, while, in the first and second embodiments, the recording management information is recorded into the two areas of the disk device 105 and the magnetic disk 111 as an example, the recording management information may be recorded into an area, or three or more areas. Further, in a case where the recording management information is recorded into three or more areas, the recording management information is recorded into three or more areas sequentially.

Further, while, in the first and second embodiments, the backup information is included in the recording management information stored in the volatile memory held by the recording management information management means 107 as an example, it is also possible that the recording management information stored in the volatile memory held by the recording management information management means 107 does not include the backup information and the recording management information management means 107 adds the backup information when outputting the recording management data to the data recording and reproduction means 104.

Further, while, in the first and second embodiments, digital data composed of image data and voice data are recorded or reproduced onto/from a disk-shaped recording medium of the disk device 105 or the magnetic disk 111, digital data may be composed of either one of image data and voice data.

Applicability in Industry

As described above, a recording and reproduction disk device and a disk device according to the present invention record digital data onto a magnetic disk or an optical magnetic disk and are suited for a magnetic disk device or optical magnetic disk device such as a hard disk device.

1. A recording and reproduction disk control unit which controls recording and reproduction of digital data onto/from a disk-shaped recording medium that has a data recordable area where the digital data composed of either one or both of image data and voice data are recorded and one or more management information areas where recording management information employed for management of the digital data is recorded, comprising:
a data recording and reproduction means for recording digital data and recording management information onto the disk-shaped recording medium and reading the digital data and the recording management information from the disk-shaped recording medium;
an image/voice data management means for monitoring whether there is a room for recording of digital data by the data recording and reproduction means or not; and
a recording management information management means for temporarily holding recording management information and outputting the recording management information to the data recording and reproduction means when the image/voice data management means detects that there is a room for recording of the digital data by the data recording and reproduction means.

2. The recording and reproduction disk control unit as defined in claim 1, wherein
the disk-shaped recording medium has two or more management recording areas, and
the data recording and reproduction means records recording management information in the two or more management information areas in turn when recording the recording management information onto the disk-shaped recording medium.

3. The recording and reproduction disk control unit as defined in claim 2, wherein
the recording management information recorded on the disk-shaped recording medium includes recording recency information which indicates whether the recording management information is most newly recorded, as backup information.

4. The recording and reproduction disk control unit as defined in claim 2, wherein
the recording management information recorded on the disk-shaped recording medium includes disconnection-during-recording information which indicates whether or not power disconnection of the disk recording and reproduction control unit is generated while the recording management information is recorded on the disk-shaped recording medium, as backup information.

5. The recording and reproduction disk control unit as defined in claim 2, wherein
the recording management information recorded on the disk-shaped recording medium includes operational state information which indicates whether the recording management information is recorded on the disk-shaped recording medium during recording of digital data or not, as backup information.

6. The recording and reproduction disk control unit as defined in claim 2, wherein
backup information, information concerning recording of the recording management information, is included in the recording management information recorded on the disk-shaped recording medium,
the backup information is not included in the recording management information temporarily held by the recording management information management means, and
the recording management information management means adds the backup information to the recording management information temporarily held by the recording management information management means to output to the data recording and reproduction means.

7. The recording and reproduction disk control unit as defined in claim 2, wherein
the recording management information recorded on the disk-shaped recording medium includes backup information as information concerning recording of the recording management information,
the recording management information temporarily held by the recording management information management means includes the backup information, and
the recording management information management means updates the backup information included in the recording management information temporarily held by the recording management information management means to output to the data recording and reproduction means.

8. The recording and reproduction disk control unit as defined in claim 2, wherein
the recording management information management means selects the recording management information which is most newly recorded with no power disconnection generated during recording from recording management information recorded on the disk-shaped recording medium at startup of the recording and reproduction disk control unit.

9. A disk device having the recording and reproduction disk control unit as defined in claim 1 built-in.
